(19) United States
(12) Patent Application Publication
(10) Pub. No.: US 2022/0331995 A1
(43) Pub. Date: Oct. 20, 2022

(54) SYSTEM AND METHOD FOR DEPLOYING A COLLABORATIVE ROBOT IN A GLOVEBOX

(71) Applicant: ATKINS LIMITED, Moor Row (GB)

(72) Inventors: James O'BRIEN, Moor Row (GB); Chris SANDERSON, Moor Row (GB); Ben LOGAN, Moor Row (GB); Samuel T. STEPHENS, Moor Row (GB)

(21) Appl. No.: 17/753,912

(22) PCT Filed: Sep. 18, 2020
(86) PCT No.: PCT/IB2020/058708

§ 371 Date: Mar. 18, 2022

Related U.S. Application Data
(60) Provisional application No. 62/902,267, filed on Sep. 18, 2019.

(51) Int. Cl. B25J 21/02; B25J 5/00; B25J 19/02

(52) U.S. Cl. CPC B25J 21/02; B25J 5/007; B25J 19/023

(57) ABSTRACT

A system (1) and method for deploying a collaborative robot (5) in a glovebox (10) are provided. The system comprises an adjustable trolley (2) including: a frame (3); a mounting plate (4) slideably mounted to the frame (3); one or more pulleys (15) configured to move the mounting plate (4) along a longitudinal axis of the adjustable trolley (2); and a plurality of wheels (9) configured to move the adjustable trolley (2) forward, backward, and rotate about the longitudinal axis of the adjustable trolley (2); a collaborative robot (5) having a proximate end and a distal end, the proximate end mounted to the mounting plate (4), and the distal end comprising an end effector (13); and a glove (7) configured to receive the collaborative robot (5), and to sealably couple with a port (11) of the glovebox (10).

### CROSS-REFERENCE TO RELATED APPLICATIONS

This application claims all benefit including priority to U.S. Provisional Patent Application 62/902,267, filed Sep. 18, 2019, and entitled “System and Method for Deploying a Collaborative Robot in a Glovebox”, the entirety of which is hereby incorporated by reference.

### FIELD

The present disclosure generally relates to handling hazardous materials and in particular to gloveboxes.

### BACKGROUND

A glovebox is a sealed container that allows a user to manipulate object(s) in a separate atmosphere. Typical gloveboxes are arranged such that a user can place their hands into gloves and handle material (e.g. hazardous material), without breaking containment. However, during use, the gloves may be punctured, ruptured, tear, or otherwise be damaged, resulting in a loss of containment of the hazardous materials.

### SUMMARY

In an aspect, a system for deploying a collaborative robot in a glovebox is provided. In an embodiment, the system comprises an adjustable trolley comprising: a frame; a mounting plate slideably mounted to the frame; one or more pulleys configured to move the mounting plate along a longitudinal axis of the adjustable trolley; and a plurality of wheels configured to move the adjustable trolley forward, backward, and rotate about the longitudinal axis of the adjustable trolley. The system also comprises a collaborative robot having a proximate end and a distal end, the proximate end mounted to the mounting plate, and the distil end comprising an end effector; and a glove having a proximate end and a distal end, the glove configured to receive the collaborative robot, and to sealably couple with a port of the glovebox.

In an embodiment, the system comprises a camera communicating with a display, the camera configured to provide real time images of the end effector to the display.

In another embodiment, the system comprises a controller configured to control the movement of the collaborative robot. In an embodiment, the controller is configured to receive and send signals to the collaborative robot. In another embodiment, the controller is hardwired to the collaborative robot.

In another embodiment of the system, the proximal end of the glove has a first diameter, a central section of the globe has a second diameter, and the distal end of the glove is shaped to receive the end effector.

In another embodiment of the system, the second diameter is larger than the first diameter.

In another embodiment, the system comprises fasteners positioned on or proximate to the distal end of the glove for coupling to the end effector.

In another embodiment, the system comprises an O-ring integral to the proximate end of the glove, the O-ring configured to sealably couple to the port of the glove box.

In another embodiment, the system comprises a protective sleeve sheathed around the glove.

In another embodiment of the system, the protective sleeve comprises fasteners at opposing ends of the protective sleeve, the fasteners configured to couple the protective sleeve to the glove.

In another aspect, a method of deploying a collaborative robot in a glovebox is provided. In an embodiment, the method comprises coupling a glove to a port of the glovebox with an O-ring; inverting the glove to position the glove extending from the port toward an exterior of the glovebox 10; mounting the collaborative robot on an adjustable trolley comprising: a frame; a mounting plate slideably mounted to the frame; one or more pulleys configured to move the mounting plate along a longitudinal axis of the adjustable trolley; and a plurality of wheels configured to move the adjustable trolley forward, backward, and rotate about the longitudinal axis of the adjustable trolley; the collaborative robot having a proximate end and a distal end, the proximate end mounted to the mounting plate, and the distal end comprising an end effector. The method also comprises extending the collaborative robot into a generally horizontal position such that its cross-section projects within a circumference of the port; coupling inverted glove to an end effector of collaborative robot; receiving the collaborative robot in the glove, the glove configured to define the external surface of the collaborative robot within the glove; inserting the collaborative robot through a port, and into an inner volume, of the glovebox; and forming a seal between the glove and the port to prevent contaminants from migrating between the inner volume and the collaborative robot.

In another embodiment of the method, coupling the inverted glove to the end effector comprises fastening the glove to the end effector with fasteners and positioning a camera of the collaborative robot in a camera panel of the glove

In another embodiment of the method, inserting the collaborative robot through the port comprises at least one of rotating the adjustable trolley about the longitudinal axis, moving the adjustable trolley forward or backward, and moving the mounting plate along the longitudinal axis using the one or more pulleys.

In another embodiment, the method comprises operating the collaborative robot with a controller configured to move the collaborative robot, and a camera configured to communicated with a display, to provide real time images of the end effector to the display.

In another embodiment, the method comprises extending the collaborative robot into a generally horizontal position such that its cross-section projects within the circumference of port; moving the adjustable trolley away from the glovebox; decoupling the collaborative robot from glove; installing a replacement glove onto the port; and disconnecting the glove from port for disposal.

In another embodiment, the method comprises decontaminating the collaborative robot.

In an aspect, an adjustable trolley is provided. The adjustable trolley comprises: a frame; a mounting plate slideably mounted to the frame, the mounting plate configured to receive a collaborative robot; one or more pulleys configured to move the mounting plate along a longitudinal axis of the adjustable trolley; and a plurality of wheels configured to move the adjustable trolley forward, backward, and rotate about the longitudinal axis of the adjustable trolley.

In an embodiment, the adjustable trolley comprises a controller configured to control the movement of the collaborative robot.

In an embodiment of the adjustable trolley, the controller is configured to receive and send signals to the collaborative robot.

In an aspect, a glove for receiving a collaborative robot is provided. The glove comprises: a proximate end for coupling to port of a glovebox, the proximate end extending a first length having a first diameter; a central portion coupled to the proximate end, the central portion having a second diameter; a distal end coupled to the central portion, the distal end shaped to receive an end effector of the collaborative robot.

In an embodiment of the glove, the second diameter is larger than the first diameter.

In an embodiment of the glove, the central portion is coupled to the proximate end with a first tapered shoulder, and the distal end is coupled to central portion is coupled to the central portion with a second tapered shoulder.

In an embodiment, the glove comprises fasteners positioned on or adjacent to the distal end of the glove for coupling the glove to the end effector.

In an embodiment, the glove comprises an O-ring integral to the proximate end of the glove, the O-ring configured to sealably couple to the port of the glove box.

In an embodiment, the glove comprises a protective sleeve defining at least a portion of at least one of the proximate end, central portion, or distal end of the glove. The protective sleeve may comprise fasteners at opposing ends of the protective sleeve, the fasteners configured to couple the protective sleeve to at least one of the proximate end, central portion, or distal end of the glove.

### BRIEF DESCRIPTION OF DRAWINGS

In the figures, which depict example embodiments:

FIG. 1 is a perspective view of a system for deploying a collaborative robot in a glovebox, and a glovebox.

FIG. 2 is another perspective view of the system shown in FIG. 1

FIG. 3A is a perspective view of the system shown in FIG. 1 inserted into the glovebox.

FIG. 3B is another perspective view of the system shown in FIG. 3B.

FIG. 4A is a rear perspective view of a system for deploying a collaborative robot in a glovebox, the system comprising an adjustable trolley for mounting a collaborative robot. The adjustable trolley comprises a pulley system configured to change the vertical position of a mounting flange.

FIG. 4B is a is a front perspective view of the system shown in FIG. 4B.

FIG. 5A illustrates a front view of the mounting flange shown in FIGS. 4A and 4B.

FIG. 5B illustrates a mounting plate mounted on the mounting flange shown in FIG. 5A.

FIG. 6 illustrates a perspective view of a base of a collaborative robot mounted on the mounting plate of FIG. 5B.

FIG. 7 illustrates an example collaborative robot mounted on an adjustable trolley.

FIGS. 8A and 8B each illustrate a perspective view of the collaborative robot of FIG. 7 received within a glove.

FIG. 9 illustrates four example gloves for receiving a collaborative robot according to different embodiments.

FIGS. 10A and 10B illustrates a cross-section of example gloves for receiving a collaborative robot.

FIG. 11 illustrates a cross-section of an example protective sleeve.

FIGS. 12A and 12B each illustrate protective sleeve covering glove 7 from a proximal end of the collaborative robot 5 to an end effector.

FIG. 13 is a schematic diagram of an example controller.

### DETAILED DESCRIPTION

In an aspect, a system for deploying a collaborative robot in a glovebox is provided. The system may be developed to deploy a collaborative robot (i.e. a robotic arm) into a glovebox (e.g. an alpha glovebox) on a nuclear licensed site. The system may be implemented to augment an existing glovebox with a collaborative robot which may reduce the risk of accidental exposure to material in the glovebox as a user is not required to manually reach into the glovebox.

The system may reduce risk to operators of gloveboxes by providing a remote system that will substitute a physical human interaction in the glovebox with a robotic twin of the operator. The system may be controlled remotely which may mitigate exposure risk to users when the content of a glove box contain hazardous material, e.g. material that gives off gamma radiation, which is potentially hazardous to a user even when contained in a glovebox.

While embodiments of the invention are described in relation to nuclear technology, the example systems, methods and/or devices described herein may be adapted and/or implemented for use in any glovebox used in research, industrial, pharmaceutical, and/or chemical operations. In some embodiments, the example systems, methods and/or devices described herein may be adapted and/or implemented for use in any application or environment where it may be beneficial to physically isolate/insulate a human operator from objects being manipulated and/or the environment in which those objects are situated.

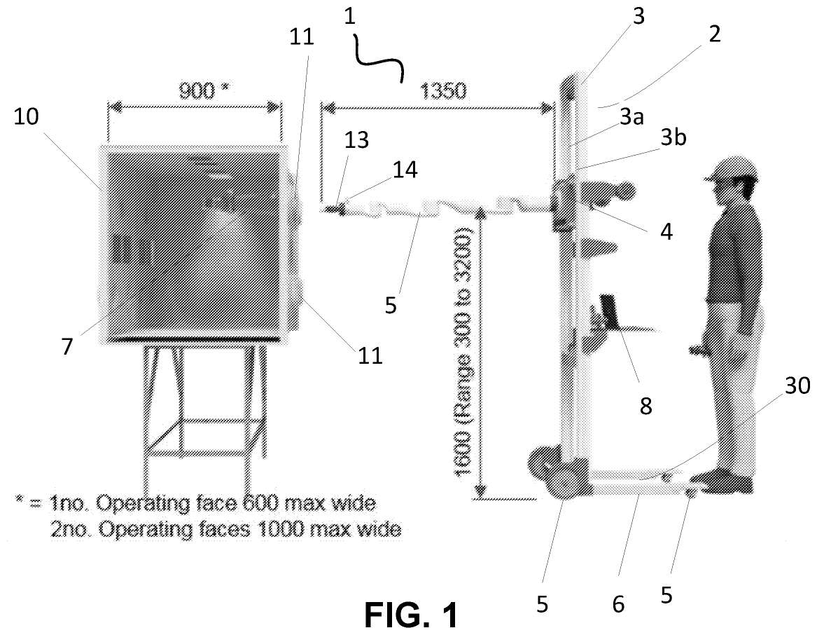

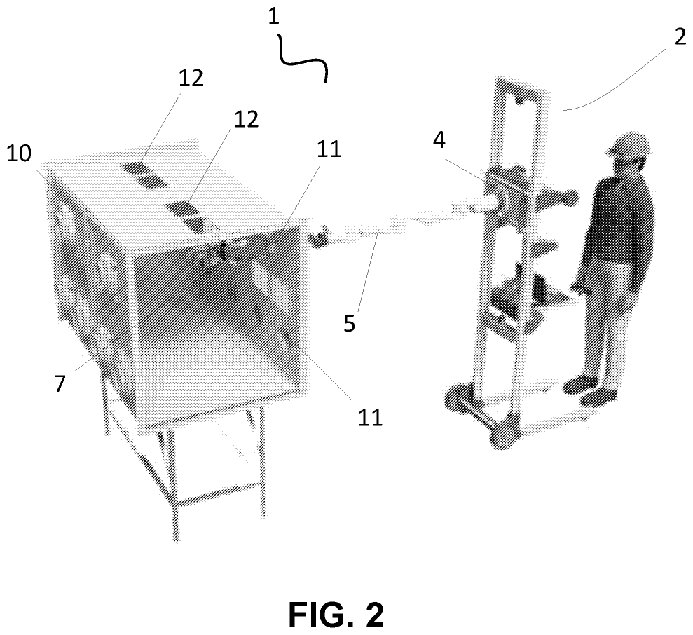

FIG. 1 and FIG. 2 illustrate an example system 1 for deploying a collaborative robot in a glovebox. In an embodiment, the collaborative robot is a gen3 collaborative robot produced by Kinova™. The system 1 comprises an adjustable trolley 2 having a frame 3 on which a mounting plate 4 is slidably or otherwise moveably mounted. In some embodiments the mounting plate 4 is moveable to enable the attachment height of collaborative robot to be between 0.5-2 m, or any other suitable range. In an example, vertical members 3a, 3b of frame 3 may be rails defining an opening in which mounting plate 4 is positioned. Mounting plate 4 may be slidably moved with respect to frame 3, along a longitudinal axis of the adjustable trolley 2 (e.g. a vertical axis), to position collaborative robot 5 for insertion into glovebox 10. Collaborative robot 5 may be mounted onto mounting plate 4. As shown, collaborative robot 5 is configured to orient itself to extend along a horizontal plane for insertion into a port 11 or the glovebox 10. Adjustable trolley 2 may have wheels 9 to allow trolley 2 to be rolled into position such that collaborative robot 5 may be inserted into glovebox 10. Adjustable trolley 2 may also have a base 30 comprising one or more support members 6 extending from frame 3 which are configured to keep frame 3 upright. Wheels 9 are connected to trolley 2 to permit the trolley to rotate about its longitudinal axis and move forward/backward so that collaborative robot 5 may be correctly positioned and inserted through port 11. A display 8 configured to show an output from a controller 1300 for controlling the collaborative robot 5 may also be provided on adjustable trolley 3.

Because adjustable trolley 2 is rotatable about its longitudinal axis, moveable forward/backward, and configured to raise/lower the collaborative robot 5, the collaborative robot 5 may be inserted into a glovebox in its existing configuration without disconnecting and/or relocating the glovebox from it current application. In some situations, moving a glovebox from its original position may be unsafe or physically impossible.

In an embodiment, system 1 comprises a glove 7 configured to be mounted on port 11 and to receive collaborative robot 5. As shown, in FIGS. 1 and 2, glove 7 may be mounted on port 11 prior to collaborative robot 5 being inserted into glove 7. As such, when collaborative robot 5 is inserted into glove box 10, the ventilation system (not shown) may be live at all times within the glovebox to withdraw gas from glovebox 10 through vent holes 12. Example ports 11 of glovebox 5 may have any diameter, e.g. a 6″, 8″, 10″ diameter, and collaborative robot 5 may be configured to fit through port 11. Example gloveboxes having 6″ (152 mm) glove ports may have a Hypalon™ glove providing containment. Other example glove ports include: Harwell type—which has a spigot to host a double O-ring arrangement; and CRL Push Through glove port. Glovebox 10 may also include bagging ports which are typically 8″ (205 mm) and 10″ (254 mm) used to post waste out of the glovebox. In an embodiment, gloves according to this disclosure may be made of Hypalon™ or industrial PVC having welded seams.

Collaborative robot 5 may also be configured to be operable with the inner volume of glovebox such that end effector 13 may reach all internal surfaces of glovebox 5 defining the inner volume of glovebox 5.

End effector 13 of the collaborative robot 5 may be positioned at a distal end of the collaborative robot 5. A proximate end of collaborative robot 5 may be mounted to mounting plate 4. End effector 13 may be a 2-digit end effector that may be controlled to perform handling functions including: Remote Vacuuming Decontamination; Remote Contamination Fixative Application with Spray Gun; Remote In Glovebox Alpha Characterisation Survey with Americium Camera; and Remote Handling of Non-Fixed Items for posting out of glovebox.

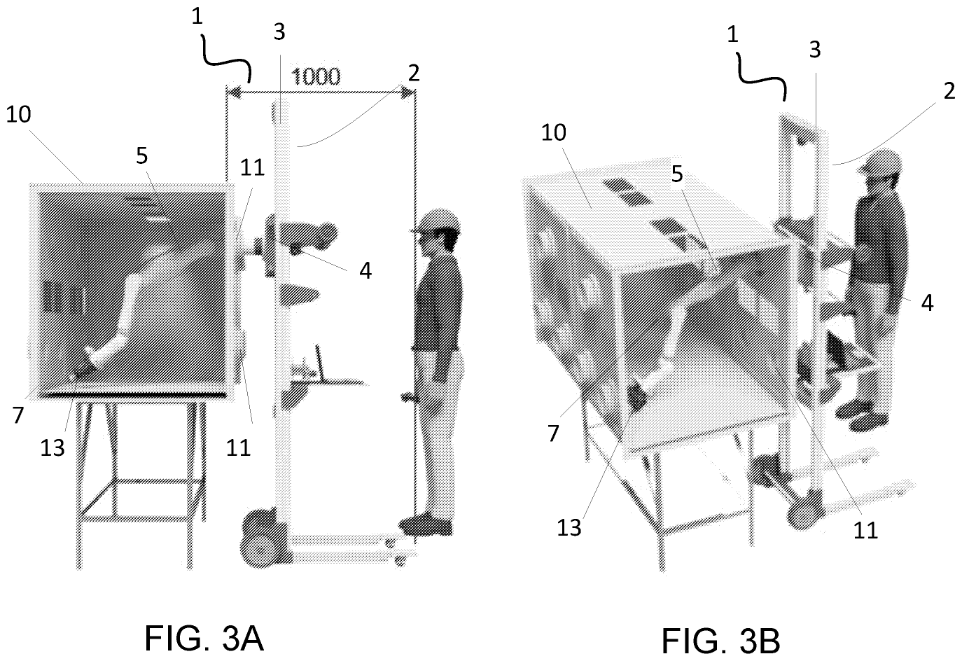

A camera 14 may be provided on the collaborative robot 5 to observe and shown end effector 13 on display 8. A user may control the movement of collaborative robot 5, and end effector 13, using an input device 29a, b, e.g. gaming controller or other suitable input controller that may configured to move a collaborative robot. In an embodiment, the input controller 29a is hardwired to computing device 1300 to control the collaborative robot 5 on site. In another embodiment, the input controller may be a remote controller 29b which communicates through a network 1301 to control collaborative robot 5. FIGS. 3A and 3B. illustrate collaborative robot 5 within glovebox 10 through a port 11. Glove 7 is configured to receive collaborative robot 5 without being tore or ripped. In an embodiment, glove 7 is made of a resilient material, e.g. Hypalon or industrial PVC having welded seams, that is deformable to permit collaborative robot 5 to be received within glove 7, and to permit collaborative robot 5 to move within the inner volume of glovebox 10, without ripping, tearing, or otherwise rupturing due to movement of the collaborative robot 5 within glovebox 10. Glove 7 is also configured to be mounted on port 11 to form a seal to prevent gas, radiation, or other contaminated material between glove 7 and glovebox 10 from passing through port 11 to the exterior of glovebox 10.

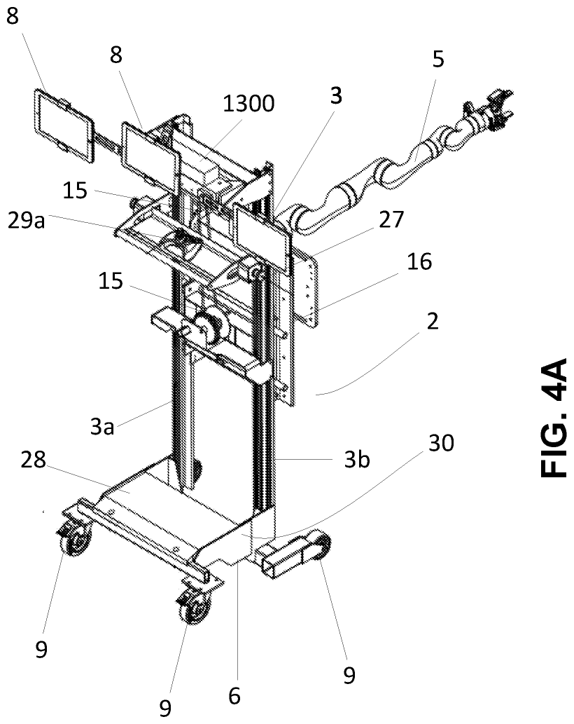

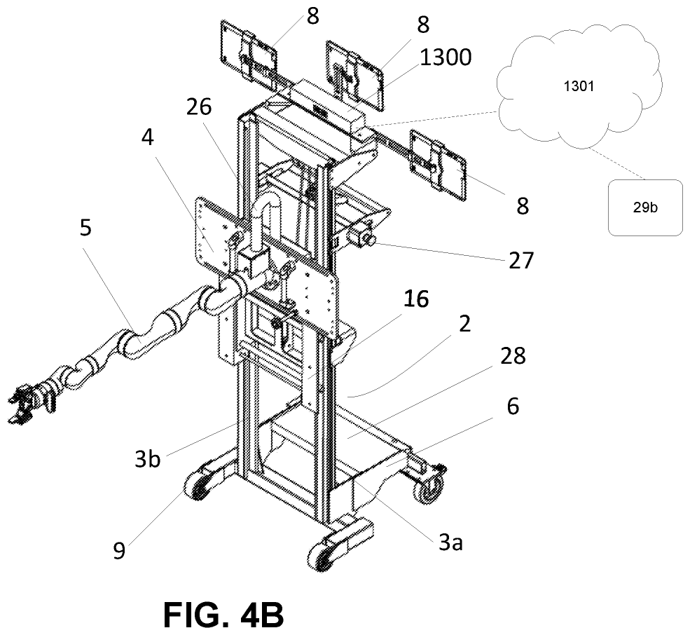

FIGS. 4A and 4B, illustrate an adjustable trolley 2 and collaborative robot 5 according to an embodiment of the system of the present disclosure. Pulley system 15 may comprise one or more pulleys mounted on frame 3, the pulley system 15 configured to change a vertical position of one or more mounting flange(s) 16 to position collaborative robot to be inserted into and pass through port 11. Mounting flange(s) 16 are configured to be connected to mounting plate 4. Counterweight 28 is provided to maintain stability of adjustable trolley. As shown in FIG. 4A, counterweight 28 may be positioned at or near a base 30 of adjustable trolley 2 extending from frame 3. In an embodiment, counterweight 28 may be about 40 kg and is integrated into base 30 of the assembly to counteract the overturning moment from the collaborative robot arm when it is fully extended. In some embodiments, the counterweight 28 is sized and positioned to counteract the overturning moment from the collaborate robot arm when it is attached at any mounting position on the trolley. Counterweight 28 may be configured to provide a margin of safety to preclude overturning of the adjustable trolley 2 without adversely affecting the overall mass and therefore maneuverability of the system.

In an embodiment, adjustable trolley 2 may also be provided with collaborative robot motive force emergency stop button 27. Emergency stop button 27 may be located on the side of adjustable trolley 2 opposing near collaborator robot near the operator and configured to cut power to the collaborative robot in the event of malfunction or operator error.

In some embodiments, then the emergency stop button 28 is activated, the controller is configured to put the collaborative robot in a fault state in which the collaborative robot maintains its position until the fault state is cleared.

FIG. 4B illustrates a front perspective view of adjustable trolley 2. Adjustable trolley 2 may be provided with cable channel 26 to convey power and/or data cables from collaborative robot 5 to a power source (not shown), input device/controller 29a, b, display 8, or other desired power and/or data connection to control collaborative robot 5. Cable channel 26 may convey power and/or data cables to collaborative robot 5 such that the cables do not tangle or interfere with collaborative robot 5 in operation or mounting plate 4 when it moves relative to frame 4. In an embodiment, cable channel 26 may be flexible ducting connecting to collaborative robot 5 at a first end and a computer system 1300 at a second end which may receive data from controller 29a, b and/or collaborative robot 5 and transmit data to display 8 and/or collaborative robot 5.

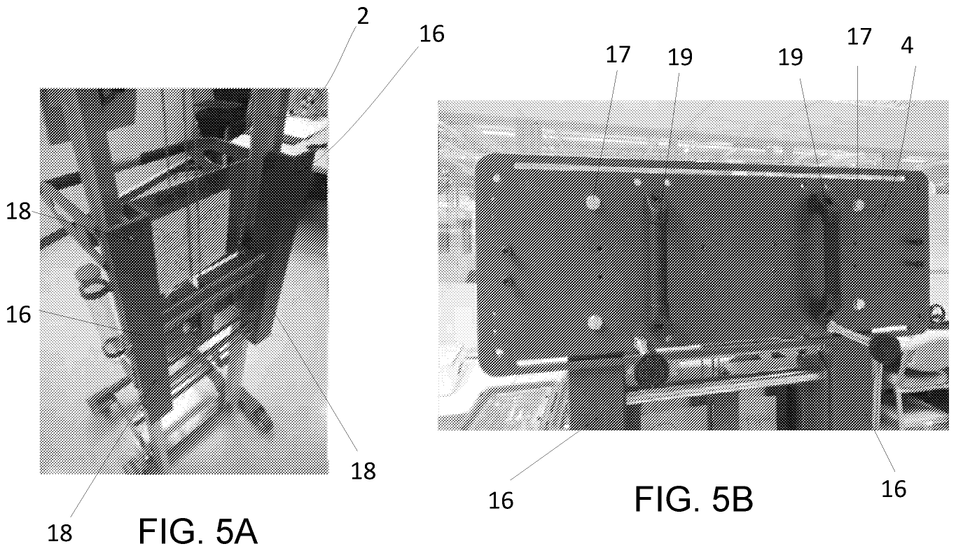

FIG. 5A illustrates mounting plate 4 mounted on mounting flange(s) 16. Mounting plate 4 may be secured to mounting flange(s) 16 by fasteners 17 (e.g. bolts) that extend through holes 18 in mounting flange(s) 16. Mounting plate 4 may include handles 19 to provide a user with a handhold when lifting or securing mounting plate 4 to mounting flange(s) 16. Mounting plate 4 has three potential mounting positions for the collaborative robot 5 to enable accessibility into a glovebox with a left handed port, a right handed port or one in the middle of the glovebox. An example glovebox having a left handed and right handed port is illustrated in FIGS. 2, 3A, and 3B.

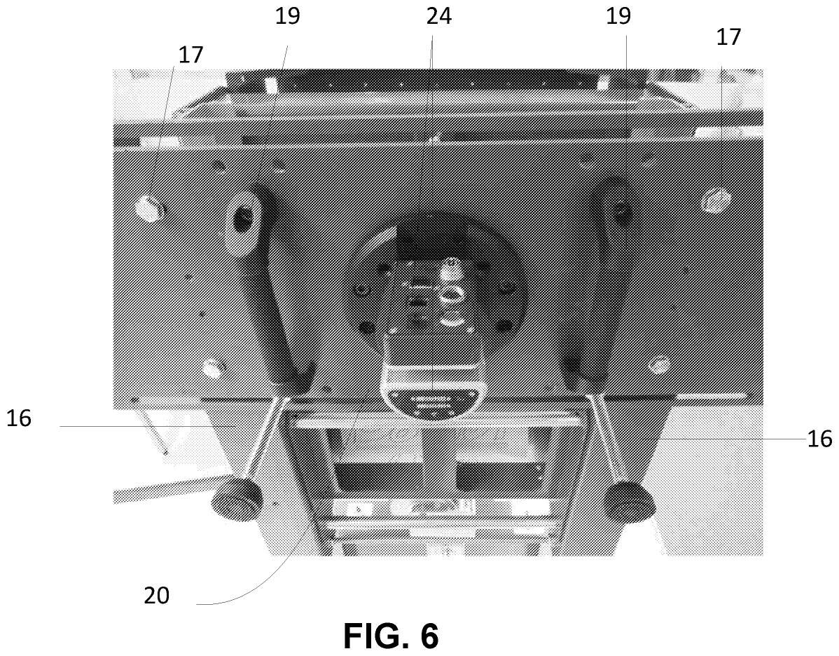

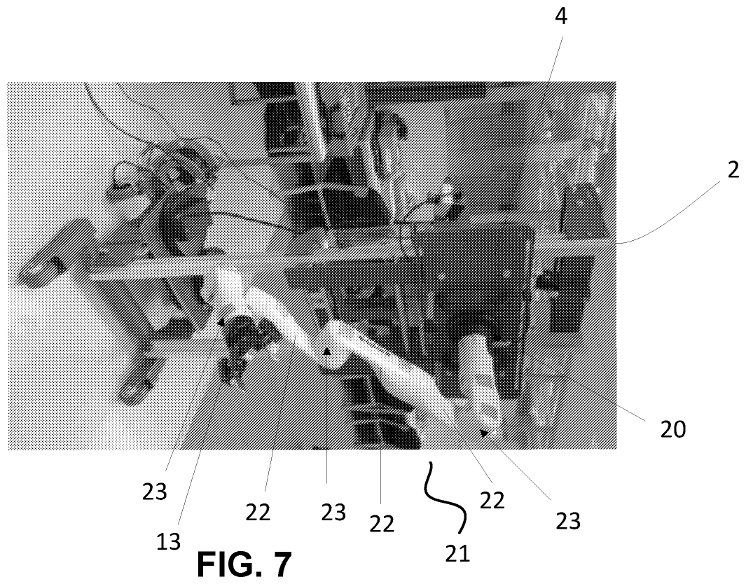

FIG. 6 illustrates a collaborative robot base 20 mounted on mounting plate 4. Base 20 may be mounted to mounting plate 4 with fasteners (e.g. screws). As shown, base 20 may comprise one or more ports 24 to convey data, power, and signals to/from a driven segment 21 of collaborative robot 5 (i.e. a segment of the collaborative robot is driven by motors to perform commands from a user). When collaborative robot 5 is engaged with glovebox 10, base 20 may be stationary and non-moving. As shown in FIG. 7, base 20 may define the proximate end of collaborative robot 5 and is configured to couple with a driven segment 21 of collaborative robot 5. Driven segment 21 may comprise a plurality of arm links 22 each connected at a link drive 23 configured to move a neighbouring arm links about an axis with respect to the link drive.

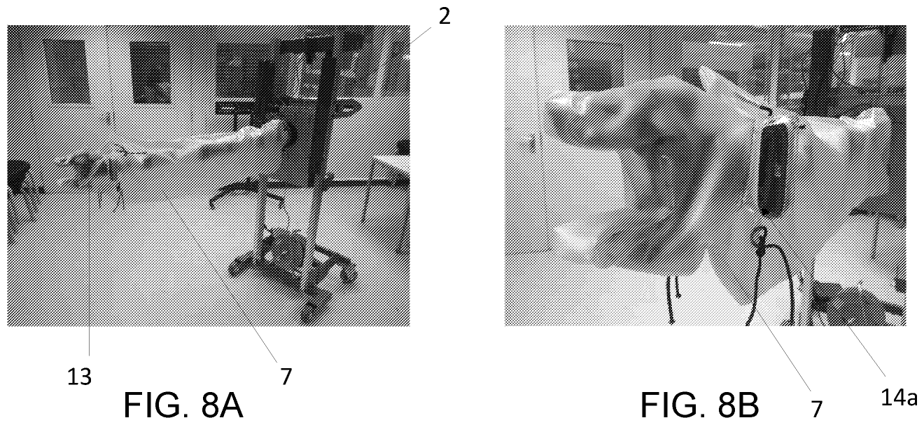

Prior to being inserted through port 11 into glovebox 10, collaborative robot 5 may be received within glove 7. As shown in FIGS. 8A and 8B, glove 7 is shaped to receive collaborative robot 5, and in particular end effector 13. In the embodiment illustrated in FIGS. 8A and 8B, glove 7 is shaped to receive a 2-digit end effector. Glove 7 may also comprise a camera panel 14a for receiving a camera 14 to view the positioning of the end effector, the camera panel having a seal to sealably coupled to camera 14 to prevent contaminants with glovebox 10 migrating within glove 7.

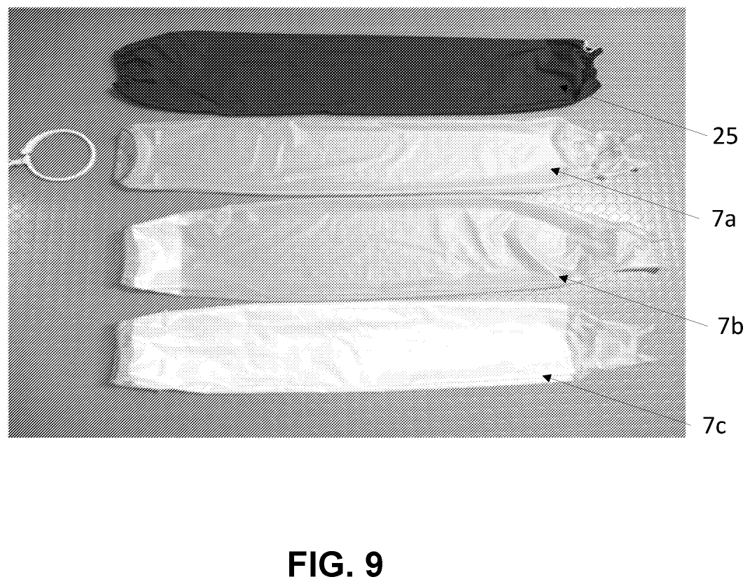

Several example embodiments of gloves for receiving a collaborative robot are illustrated in FIG. 9. Example glove 7a, illustrates a straight 8″ tube with simple cut out for a camera panel 14 and a distal end shaped to receive the robot end effector, e.g. a 2-digit end effector. Through testing and refinement of the design, glove 7b was created to shape the distal end of glove 7b around the end effector of the collaborative robot to enable almost full dexterity of the two fingers, additional reinforcement around the end effector was added to eliminate the risk of tearing or puncturing, and additional ripstop material was added at the proximate end of glove 7b was added around near gloveport. Glove 7c is similar to glove 7b except that is comprises ripstop material which extends nearly along its entire length except for the distal end portion configured to cover an end effector of a collaborate robot.

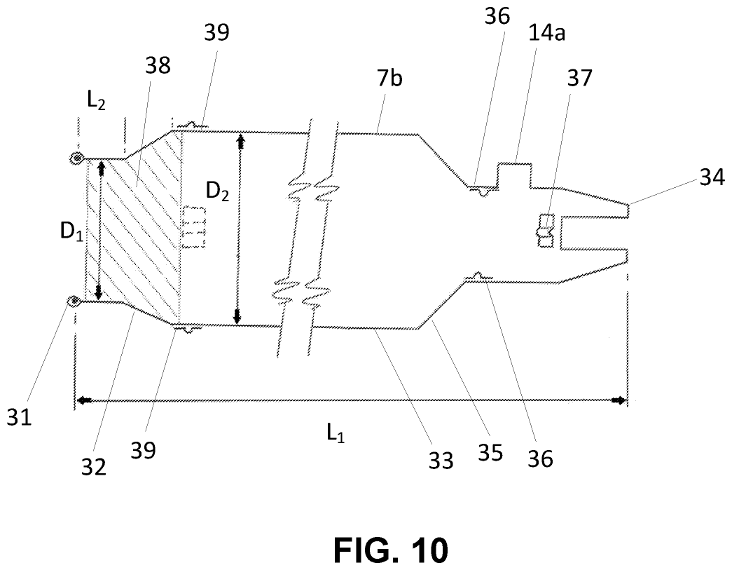

FIG. 10 illustrates a cross-sectional view of example glove 7b. D1 illustrates an internal diameter of the glove at proximal end 31 of the glove. Proximate end 31 may comprise an integrated O-ring for airtight coupling with a port of a glovebox. In an embodiment, diameter D1 may be about 6 inches (15.24 cm). Proximate end 31 may extend a length L2, e.g. about 100 mm, to first tapered shoulder 32 which expands to the internal diameter D2 of glove 7b in a central portion 33 between proximate end 31 and distal end 34. Diameter D2 may be about 9 inches (22.86 cm). Central portion 33 extends to second tapered shoulder 35 which narrows the internal diameter of glove 7b to a neck portion at the end effector.

Neck portion may comprise one or more fasteners 36, e.g. loop fasteners or cord and clamp fasteners, positioned radially around glove 7b to couple glove 7b to collaborate robot 5 between camera panel 14a and second tapered should 35. Glove 7b may also comprise one or more fasteners 37, e.g. loop fasteners or cord and clamp fasteners, which may be positioned for coupling glove 7b to an end effector of collaborative robot 5. Fasteners 37 may be positioned adjacent to or generally near the jaw of the digits of the end effector. Fasteners 36 and 37 may be configured to collect excess material of glove 7b such that it does not catch, become tore, or encumber the movement of collaborative robot 5 when received in glove 7b. By fastening material of glove 7b to end effector, the material around the end effector will not catch or interfere with the operation of end effector when in use. Diameter D2 of central portion 33 is configured to allow collaborative robot 5 to turn and move without ripping glove 7b. As shown in FIG. 10, glove 7b may also comprise ripstop material 38 illustrated in hatched lines to mitigate against glove 7b ripping during operating of collaborative robot 5. In an embodiment, ripstop material 38 may be positioned from proximal end to central portion 33 as shown in FIG. 10. In another embodiment, ripstop material 38 may extend from proximal end 31 and include the entirety of central portion 33 to second shoulder 35 as illustrated in glove 7c.

Gloves according to the disclosure herein are not limited to a specific material. In an embodiment, a glove according to the disclosure herein may be an industrial grade PVC or Hypalon, which may be about 300 μm thick, and camera panel 14a that may be a transparent industrial grade PVC or Hypalon which may be about 250 μm thick.

In some embodiments, the glove includes or is made of a material suitable for isolating, insolating or otherwise reducing exposure between the collaborative robot and the environment and/or objects in the glovebox without restricting motion of the collaborative robot more than is necessary for the robot to perform intended functions in the glovebox.

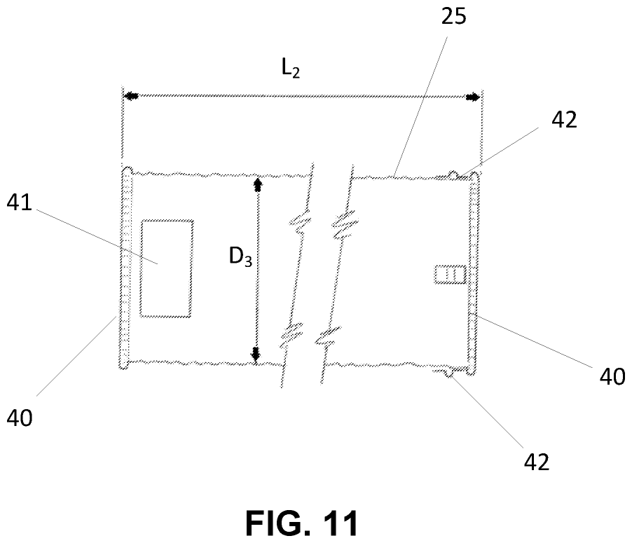

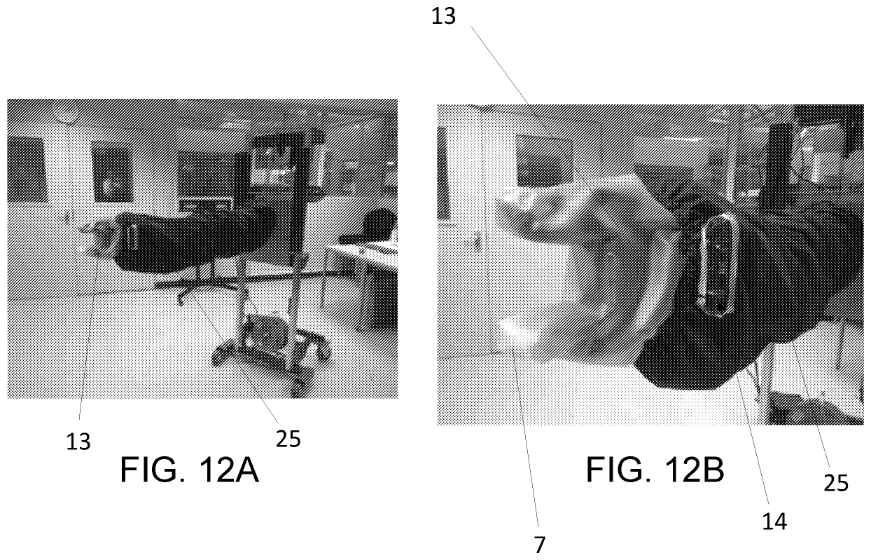

Gloves according to the disclosure herein may be configured to mount protective sleeve 25. Fasteners 39 may be position adjacent to first shoulder 32 for coupling with an inside surface of protective sleeve 25. Fasteners 39 may be a loop or other anchor point to couple to corresponding fasteners on an inside surface of protective sleeve 25. Protective sleeve 25, when mounted on gloves according to the disclosure herein, may avoid snagging and breach of the glove which could compromise the containment boundary of a glovebox. Protective sleeve 25 may also be provided to protect glove 7 (including 7a, 7b, 7c) from being torn, ripped, or punctured during use. As illustrated in FIG. 11, a cross section of protective sleeve 25 is illustrated. Protective sleeve may comprise fasteners 40 at opposing ends of the protective sleeve, e.g. elasticated ends, to secure the ends of protective sleeve 25 to glove 7 and/or collaborative robot base 20. Cutout 41 may be provided to define an aperture to receive camera panel 14a and camera 14. Fasteners 42, e.g. loop fasteners or cord and clamp fasteners, may also be positioned at a distal end of protective sleeve 25 to couple protective sleeve 25 to glove 7 near its distal end. As shown in FIGS. 12A and 12B, protective sleeve 25 may be configured to cover glove 7 from the proximal end of collaborative robot 5 to end effector 13. Protective sleeve 25 may have a length to cover all or a portion of length L1 of glove 7 extending from the proximal end 31 to the distal end 34.

A collaborative robot 5 according to this disclosure may be deployed in a glovebox, e.g. glovebox box 10 illustrated in FIGS. 1 and 2, by a method comprising: mounting collaborative robot onto adjustable trolley 2; extending collaborative robot 5 into a generally horizontal position such that its cross-section projects within a circumference of port 11; coupling glove 7 to port 11 with an O-ring; inverting glove 7 to position it such that the glove 7 extends from the port 11 toward the exterior of the glovebox 10; coupling inverted glove 7 to an end effector of collaborative robot 5; and inserting the collaborative robot through a port, and into an inner volume, of the glovebox by moving adjustable trolley 2 toward glovebox 10 to uninvert the glove and position collaborative robot 5 through port 11 in glovebox 10. In situations where the installation process is undertaken on an previously used and contaminated glovebox, containment is maintained by keeping a previously installed glove (not shown) coupled to port 11 as glove 7 and collaborative robot 5 are inserted into glovebox 10 allowing the previously installed glove to overlap (sheathing) glove 7 inside glovebox 10. Once the collaborative robot is installed within glovebox 10, the previously installed (old) gloves (not shown), which is positioned around glove 7, may be removed by decoupling an O-ring (not shown) of the previously installed glove, unsheathing the previously installed glove from glove 7, and removing the previously installed glove from through a bagging port (not shown) of glovebox 10. In an embodiment, coupling inverted glove 7 to the end effector comprises fastening the glove to the end effector with fasteners 36, 37 and positioning a camera 14 of the collaborative robot 5 in a camera panel 14a of the glove 7. In another embodiment, the method comprises coupling a protective sleeve 25 to a exterior surface of glove 7. Protective sleeve 25 may be coupled to a exterior surface of glove 7 with fasteners 39, 40. In another embodiment, protective sleeve 25 is integrally coupled to glove 7.

Collaborative robot 5 may also be withdrawn from glovebox 10 for decontamination, disposal, and/or reuse. Collaborative robot 5 may be withdrawn from glovebox 10 by extending collaborative robot 5 into a generally horizontal position such that its cross-section projects within the circumference of port 11; moving adjustable trolley 2 away from glovebox 10; decoupling collaborative robot 5 from glove 7; installing a new glove onto the port; and disconnecting glove 7 from port 11 for disposal. Glove 7 may be disconnected from glovebox 10 by decoupling its O-ring from port 11. Collaborative robot 5 may be serviced and/or decontaminated by a suitable method selected based on the hazardous material collaborative robot 5 handled. In another embodiment, glove 7 may maintain its sealed connection with port 11; collaborative robot 5 may be withdrawn from glovebox 10 by extending collaborative robot 5 into a generally horizontal position such that its cross section projects within the circumference of port 11; and adjustable trolley 2 may be moved away from glovebox 10 to withdraw collaborative robot 5 from glove 7 and glovebox 10. After being serviced and/or decontaminated, the collaborative robot 5 (or a new collaborative robot 5) may then be inserted back into glove 7 and glovebox 10.

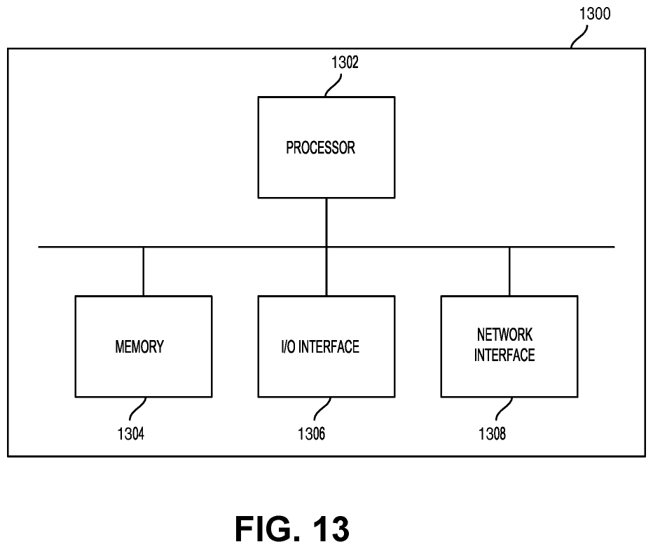

FIG. 13 is a schematic diagram of a controller 1300. In some embodiments, the controller can be or can include a computer or other computing device. As depicted, the an example computing device includes at least one processor 1302, memory 1304, at least one I/O interface 1306, and at least one network interface 1308.

Processor 1302 may be an Intel or AMD x86 or x64, PowerPC, ARM processor, or the like. Memory 1304 may include a combination of computer memory that is located either internally or externally such as, for example, random-access memory (RAM), read-only memory (ROM), compact disc read-only memory (CDROM). Each I/O interface 1306 enables controller 1300 to interconnect with one or more input devices, such as input device/controller 29, a keyboard, mouse, camera, touch screen and a microphone, or with one or more output devices such as a display screen 8 and a speaker. In some embodiments, the I/O interface 1305 provides an interface for sending and/or receiving signals (such as control, feedback, position and/or sensor signals and/or the like) to the collaborative robot.

Each network interface 1308 enables controller 1300 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others. In embodiments, the network interface 1308 enables the controller 1300 to communicate over Bluetooth™, RF, and/or any other radio-based or other wireless communication protocol 1301 with other components (e.g. monitors, controller, collaborative robot, cameras, etc.)

Controller 1300, in some embodiments, may communicate, via network 1301, with a remote controller 29b to control collaborative robot 5.

Applicant notes that the described embodiments and examples are illustrative and non-limiting. Practical implementation of the features may incorporate a combination of some or all of the aspects, and features described herein should not be taken as indications of future or existing product plans.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the detailed embodiments described above and illustrated are intended to be examples only. The invention is defined by the appended claims.

The claims are not intended to include, and should not be interpreted to include, means-plus- or step-plus-function limitations, unless such a limitation is explicitly recited in a given claim using the phrase(s) “means for” or “step for,” respectively.

1. A system for deploying a collaborative robot in a glovebox, the system comprising:
an adjustable trolley comprising:
a frame;
a mounting plate slideably mounted to the frame;
one or more pulleys configured to move the mounting plate along a longitudinal axis of the adjustable trolley; and
a plurality of wheels configured to move the adjustable trolley forward, backward, and rotate about the longitudinal axis of the adjustable trolley;
a collaborative robot having a proximate end and a distal end, the proximate end mounted to the mounting plate, and the distal end comprising an end effector; and
a glove having a proximate end and a distal end, the glove configured to receive the collaborative robot, and to sealably couple with a port of the glovebox.

2. The system of claim 1, comprising a camera communicating with a display, the camera configured to provide real time images of the end effector to the display.

3. The system of claim 1, comprising a controller configured to control the movement of the collaborative robot.

4. (canceled)

5. (canceled)

6. The system of claim 1, wherein the proximal end of the glove has a first diameter, a central section of the globe has a second diameter, and the distal end of the glove is shaped to receive the end effector.

7. The system of claim 6, wherein the second diameter is larger than the first diameter.

8. The system of claim 6, comprising fasteners positioned on or adjacent to the distal end of the glove for coupling the glove to the end effector.

9. The system of claim 1, comprising an O-ring integral to the proximate end of the glove, the O-ring configured to sealably couple to the port of the glove box.

10. The system of claim 1, comprising a protective sleeve sheathed around the glove.

11. The system of claim 10, wherein the protective sleeve comprises fasteners at opposing ends of the protective sleeve, the fasteners configured to couple the protective sleeve to the glove.

12. A method of deploying a collaborative robot in a glovebox, the method comprising:
coupling a glove to a port of the glovebox with an O-ring;
inverting the glove to position the glove extending from the port toward an exterior of the glovebox;
mounting the collaborative robot on an adjustable trolley comprising:
a frame;
a mounting plate slideably mounted to the frame;
one or more pulleys configured to move the mounting plate along a longitudinal axis of the adjustable trolley; and
a plurality of wheels configured to move the adjustable trolley forward, backward, and rotate about the longitudinal axis of the adjustable trolley;
the collaborative robot having a proximate end and a distal end, the proximate end mounted to the mounting plate, and the distal end comprising an end effector;
extending the collaborative robot into a generally horizontal position such that its cross-section projects within a circumference of the port;
coupling inverted glove to an end effector of the collaborative robot;
receiving the collaborative robot in the glove, the glove configured to define the external surface of the collaborative robot within the glove;
inserting the collaborative robot through a port, and into an inner volume, of the glovebox; and
forming a seal between the glove and the port to prevent contaminants from migrating between the inner volume and the collaborative robot.

13. The method of claim 12, wherein inserting the collaborative robot through the port comprises at least one of rotating the adjustable trolley about the longitudinal axis, moving the adjustable trolley forward or backward, and moving the mounting plate along the longitudinal axis using the one or more pulleys.

14. The method of claim 12, comprising operating the collaborative robot with a controller configured to move the collaborative robot, and a camera configured to communicated with a display, to provide real time images of the end effector to the display.

15. The method of claim 12, comprising:
extending the collaborative robot into a generally horizontal position such that its cross-section projects within the circumference of port;
moving the adjustable trolley away from the glovebox;
decoupling the collaborative robot from glove;
installing a replacement glove onto the port; and
disconnecting the glove from port for disposal.

16. (canceled)

17. The method of claim 12, wherein coupling the inverted glove to the end effector comprises fastening the glove to the end effector with fasteners and positioning a camera of the collaborative robot in a camera panel of the glove.

18-20. (canceled)

21. A glove for receiving a collaborative robot, the glove comprising:
a proximate end for coupling to port of a glovebox, the proximate end extending a first length having a first diameter;
a central portion coupled to the proximate end, the central portion having a second diameter;
a distal end coupled to the central portion, the distal end shaped to receive an end effector of the collaborative robot.

22. The glove of claim 21, wherein the second diameter is larger than the first diameter.

23. The glove of claim 22, wherein the central portion is coupled to the proximate end with a first tapered shoulder, and wherein the distal end is coupled to central portion is coupled to the central portion with a second tapered shoulder.

24. The glove of claim 21, comprising fasteners positioned on or adjacent to the distal end of the glove for coupling the glove to the end effector.

25. The glove of claim 21, comprising an O-ring integral to the proximate end of the glove, the O-ring configured to sealably couple to the port of the glove box.

26. The glove of claim 21, comprising a protective sleeve defining at least a portion of at least one of the proximate end, central portion, or distal end of the glove.

27. (canceled)
